(19) United States
(12) Patent Application Publication
(10) Pub. No.: US 2019/0132912 A1
(43) Pub. Date: May 2, 2019

(54) Heating Control System and Method for Switching on a Heating Load

(71) Applicant: Siemens Aktiengessllschaft, Muenchen (DE)

(72) Inventors: Axel Haase, Erlangen (DE); Philipp Zinn, Lauf (DE)

(73) Assignee: SIEMENS AKTIENGESELLSCHAFT

(21) Appl. No.: 16/162,702

(22) Filed: Oct. 17, 2018

(30) Foreign Application Priority Data
Oct. 26, 2017 (EP) 17198495.8

(51) Int. Cl. H05B 7/148; H05B 1/02; H05B 3/00

(52) U.S. Cl. CPC H05B 7/148; H05B 3/0019; H05B 1/0227

(57) ABSTRACT

A heating control system and method for switching on a heating load, wherein the heating load is controllable via forward-phase control, and wherein, at a particular instant in time, the forward-phase control has a corresponding phase control angle, where the heating load is switched on via a specifiable initial phase control angle and an ascertained effective current and a definable switch-on current curve are taken into account in order to determine the subsequent phase control angles such that an efficient cold start with any heating loads can be performed.

### BACKGROUND OF THE INVENTION

### 1. Field of the Invention

The invention relates to a heating control system and method for switching on a heating load, where the heating load is controllable by a forward-phase control technique having a phase control angle.

### 2. Description of the Related Art

Methods for switching on a heating load are particularly used in industrial heating processes, such as for curing coating products and tempering workpieces, in the automotive industry or even in the plastics processing industry.

These processes often employ radiant heaters, which have cold-start characteristics that result in very high currents. Radiant heaters that have positive temperature coefficient (PTC) thermistor characteristics, such as tungsten-halogen radiators, are examples of such heaters. Thus, when starting up radiant heaters of this type or other heating applications featuring such adverse cold-start properties, in order to allow a safe startup that is as fast as possible, it must be ensured that existing protective devices are not overloaded and/or currents and/or powers do not exceed maximum levels. Until now, forward-phase control that uses a very conservative and fixed sequence of phase control angles has been used regardless of the heating load employed.

The phase control angle is the angle that describes the portion of a half-wave of length 180° applied to a load. The phase control angle is also known as a firing angle, in particular in the context of thyristors or triacs. There is also what is known as a reverse-phase control technique, which could be used in a similar way to the forward-phase control technique, with the difference that the half-wave is chopped off at the end and not at the beginning.

A variety of radiators having different start-up characteristics are used, in the existing methods. As a result, either the fixed angle sequence must be selected very conservatively or must be fixed anew each time based on the radiators.

### SUMMARY OF THE INVENTION

It is an object of the present invention is to allow an efficient cold start with any heating loads.

This and other objects and advantages achieved in accordance with the invention by a method, where the heating load is switched on via a specifiable initial phase control angle and the subsequent phase control angles is determined taking into account an ascertained effective current and a definable switch-on current curve.

The aim here is to select the specifiable initial phase control angle such that the resultant current can be used to deduce the resistance of the heating load at that time. In this case, however, instead of the resistance of the heating load actually having to be calculated, the current can be used in its place. Using this current, it is possible to determine and/or calculate for the subsequent phase control angles, what load is possible in order to allow a start-up process that is as efficient and fast as possible without overloading the system or any protective devices. A suitable approach is to select initial phase control angles that are as large as possible, because this prevents too large a current. An effective current in this context may be, for example, the RMS value of the current over a half-wave or over a plurality of half-waves. Equally, just individual measured values or instantaneous values in the half-wave can be used as the basis for the effective current and, hence, as the basis for the calculation/determination in accordance with the presented method. Thus, the method allows the best possible sequence of firing angles during the cold-start to be achieved in an automated matter regardless of the heating load used.

Below is an exemplary explanation of how the effective current to be taken into account can be incorporated in the calculation of a subsequent effective current to be set.

$${I}_{N + 1} = \sqrt{\frac{{I}_{setN + 1}^{2} \cdot ( {t}_{N} + {t}_{N + 1} ) - {I}_{N}^{2} \cdot {t}_{N}}{{t}_{N + 1}}} \qquad Eq . 1$$

where:
I_{N+1} is the subsequent effective current to be set, i.e., the subsequent half-wave effective value permitted according to the switch-on current curve and from which the subsequent phase control angle/firing angle to be set can be determined,
I_{setN+1} is the setpoint value at the next zero-crossing time based on the switch-on current curve,
I_{N} is the effective current to be taken into account (e.g. a total effective current since the start of the switch-on process measured using a Hall sensor),
t_{N} is the total duration of the switch-on process up to this point in time, and
t_{N+1} is the duration of the next half-wave.

Equation 1 should be considered as one possible embodiment and can be simplified by empirical values or can be stored entirely as a lookup table, such as for different protective devices or generic heating-load types.

The definable switch-on current curve defines a current curve that results in increasing effective currents that can be specified based on boundary conditions. Examples of possible boundary conditions here are the cold-start characteristics of a radiator and a maximum load rating of a protective device.

In another advantageous embodiment, the heating load exhibits Positive Temperature Coefficient (PTC) thermistor properties. The present method can thus be implemented particularly advantageously because the heating load is often in the form of a tungsten-halogen radiator, for example, and thus exhibits a pronounced PTC thermistor behavior. This means that very large currents can occur when the radiator or heating load is switched on cold for the first time, with the present embodiment of the method allowing a fastest possible start-up process for the heating load without further configuration.

In another advantageous embodiment, the initial phase control angle is at least 60°, 90° or 120°. The larger the phase control angle, the smaller the portion of the half-wave that is applied to the heating load. In other words, the larger the phase control angle, the smaller is the resultant current. This particularly conservative configuration prevents the maximum load rating of a protective device or of the overall system being already exceeded when the heating load is initially switched on. The subsequent phase control angles can thus be determined from the first approximation determined for the behavior of the heating load.

In another advantageous embodiment, the subsequent phase control angles are calculated and/or determined from the ascertained effective current. This can be done, for instance, via a lookup table or a calculation using meter values.

In another advantageous embodiment, the initial phase control angle is selected according to a temperature of the heating load. This has the advantage that heating loads that are already preheated can be started even more quickly. In addition, this makes it easier to switch back on a heating load that has cooled slightly. For a PTC thermistor, it holds that the warmer the PTC thermistor, the greater the current that can be applied directly initially to the PTC thermistor. Thus, a less conservative selection of the first initial phase control angle is needed.

In another embodiment, the definable switch-on current curve does not exceed a characteristic curve of a protective device. The aim of a fastest possible switch-on process is to set the maximum current while preserving the system integrity. Consequently, adjusting the definable switch-on current curve based on the characteristic curve of the protective device ensures that the protective device survives the switch-on process undamaged and, hence, the integrity of the system is preserved. Although the protective device may be a single protective device in a power output, it is equally conceivable that the protective device is a higher-level protective device.

It is particularly advantageous if the distance between the definable switch-on current curve and a characteristic curve of a protective device is not less than a definable minimum distance. This ensures that the protective device remains intact and a buffer can be provided for special cases, such as in overload cases.

In another advantageous embodiment, the switch-on, i.e., the switch-on process, is concluded when a phase control angle of 50° or less has been reached. Thus, if a full wave or approximately a full wave can be switched, then it can be assumed therefrom that the operating temperature of the heating element is reached and now another control technique, such as half-wave control, can be applied.

In another advantageous embodiment, the switch-on is concluded when a phase control angle has been reached that is less than an angle defined by the controller for operation after the switch-on process. If forward phase control continues to be used after the switch-on, then the method for switching on a heating load can be concluded when currents can be set by the method that are already larger than would be stipulated by the controller. This is reflected, for instance, in a stipulated phase control angle not reaching a setpoint value.

In another advantageous embodiment, the heating load is controlled via half-wave control after the switch-on. Likewise, other common alternative forms of control are conceivable.

In another advantageous embodiment, the method for switching on a heating load is repeated when a definable cooling time is exceeded. This allows the heating load to be activated or always switched on in an optimum and rapid manner even for heating loads used only sporadically.

In another advantageous embodiment, the method is repeated whenever the heating load is switched on. The method in accordance with the disclosed embodiments of the invention can be performed extremely efficiently and quickly. Consequently, each switch-on process of the heating load can be performed using the method. This further increases the reliability and safety of the system.

It is also an object of the invention to provide a heating control system comprising a power section and a controller, where the power section is configured to control a heating load via forward-phase control having phase control angles, and where the controller controls the power section such that the heating load is switched on using a specifiable initial phase control angle, and the subsequent phase control angles are determined taking into account an ascertained effective current and a definable switch-on current curve.

### BRIEF DESCRIPTION OF THE DRAWINGS

The invention is described and explained in greater detail below with reference to the exemplary embodiments shown in the figures, in which:

FIG. 1 is a schematic circuit diagram of a power channel;

FIG. 2 is a graphical plot showing the relationship of phase control angle and effective value of the current over a half-wave;

FIG. 3 is a graphical plot showing a trip curve of a protective device and a switch-on current curve of the present method in accordance with the invention; and

FIG. 4 is a flowchart of the method in accordance with the invention.

### DETAILED DESCRIPTION OF THE EXEMPLARY EMBODIMENTS

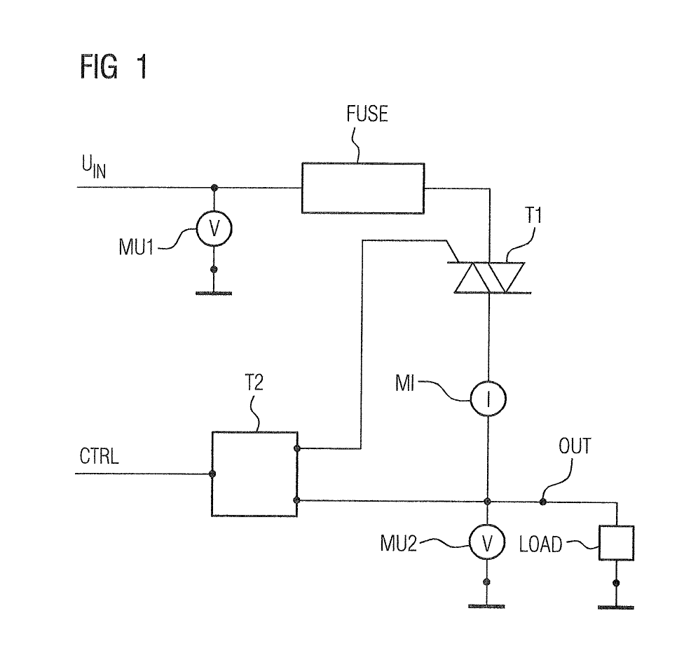

FIG. 1 shows a schematic circuit diagram of a power channel as might be used with the method in accordance with the invention. The central component is a switch T1, which here is in the form of a triac by way of example; thyristors or other power semiconductors are also conceivable. In addition, FIG. 1 shows a switch T2, which here is in the form of an opto-triac and is employed for galvanic isolation of the power channel from a controller CTRL. FIG. 1 also shows the input voltage UIN, which can be measured by a first voltage measuring device MU1, and thereafter a protective device FUSE, which protects the power channel. The current flowing through the first switch T1 is measured in the current measuring device MI. An output of the power channel OUT is equipped with a second voltage measuring device MU2, with a heating load LOAD connected to the output OUT of the power channel. It is particularly advantageous that the voltage measuring devices MU1, MU2 are not needed for the method in accordance with the invention. These have been shown for the sake of completeness and can be used, for example, for additional plausibility checking of the method and for other functionalities.

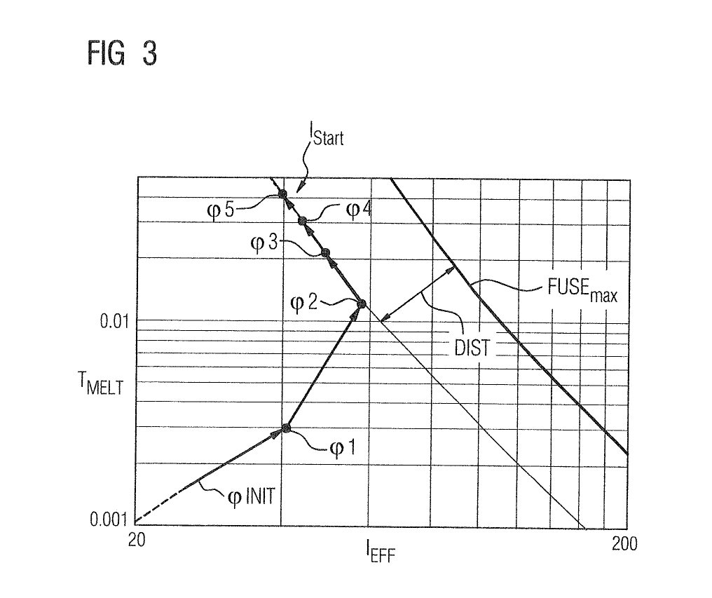

When an appropriate signal comes from the controller CTRL, the opto-triac T2 fires and the triac T1 is thereby likewise triggered. The input voltage UIN is then applied to the load OUT, and a current flows that depends on the resistance of the load LOAD at that time. Here, current measuring device MI can be in the form of a Hall sensor and provide measured current values. The first voltage measuring device MU1 is used for measuring the input voltage UIN, while the second voltage measuring device MU2 is used for measuring the voltage across the load. The controller CTRL can perform forward-phase control or reverse-phase control, and also other known techniques, such as PWM or variations. The protective device FUSE may be a fuse, for example, which has a suitable fuse characteristic curve, as shown in FIG. 3. Manufacturers of protective devices often specify time/current curves, as they are called, from which it is possible to read off how long a certain effective current value can flow on average before the protective device trips.

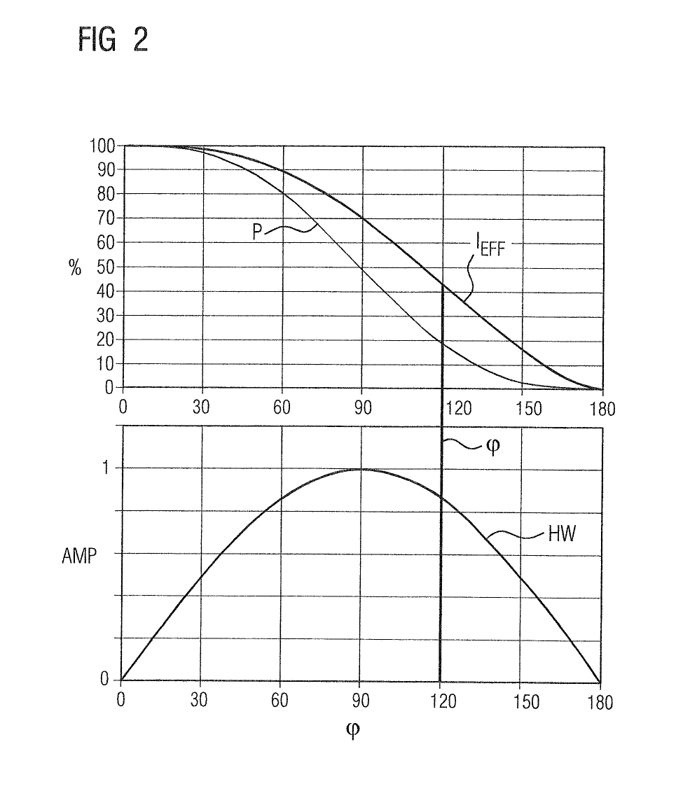

FIG. 2 shows the relationship of phase control angle φ and effective value I_{EFF} of the current over a half-wave HW. In the top graph, a normalized power in percent % is plotted on the vertical axis; both graphs span a half period of 0° to 180°. The amplitude AMP is plotted in the bottom graph and extends from 0 to 1, again in normalized form here. The top graph shows the effective current I_{EFF} that arises and the corresponding power P. The bottom graph shows a corresponding half-wave, for instance the voltage half-wave HW. A phase control angle φ of 120° is selected by way of example. Assuming that the current over time follows an ideal sinusoid, then an effective value of approximately 44% of the effective value I_{EFF} is obtained for the selected firing angle.

FIG. 3 uses a segment of a trip curve FUSEₘₐₓ of a protective device FUSE to illustrate how converging as quickly as possible on a defined switch-on current curve I_{Start}, and following this curve, is meant to be achieved via phase control angles determined by the method.

The trip curve shown is a curve that plots an effective current I_{EFF} against the melting time T_{MELT}. Here, the switch-on current curve I_{Start} exhibits a defined distance DIST from the maximum current/time curve FUSEₘₐₓ. The distance DIST could be reduced further here by a parallel shift to achieve an even faster switch-on process. The consequence of this, however, would be a reduced buffer and the design of the system would need to take this into account accordingly. The initial firing angle φ_{INIT} results in a low initial effective current I_{EFF}, and therefore it is possible to determine directly after the initial firing what subsequent load is permitted. The current is brought onto the defined switch-on current curve already using the first phase control angle φ1. The further phase control angles φ2 to φ5 are used to continue to follow accordingly the switch-on current curve I_{Start} and to allow a more efficient and faster start-up process without endangering the protective device FUSE or the power channel or even the entire heating system. The effective current I_{EFF} converges successively on the switch-on current curve I_{Start} with each of the further phase control angles φ2 to φ5. As a result of the PTC-thermistor characteristic, the resistance of the heating load falls with increasing temperature, and the phase control angles φ2 to φ5 can be adjusted accordingly.

To summarize, the invention relates to a heating control system and method for switching on a heating load LOAD, wherein the heating load LOAD can be controlled by means of forward-phase control, and wherein the forward-phase control at a particular instant has a corresponding phase control angle φ1, . . . , φn, where in order to allow an efficient cold start with any heating loads, the following steps are performed, i.e., switching on the heating load LOAD via a specifiable initial phase control angle φINIT, and determining the subsequent phase control angles φ1, . . . , φn taking into account an ascertained effective current I_{EFF} and a definable switch-on current curve I_{Start}.

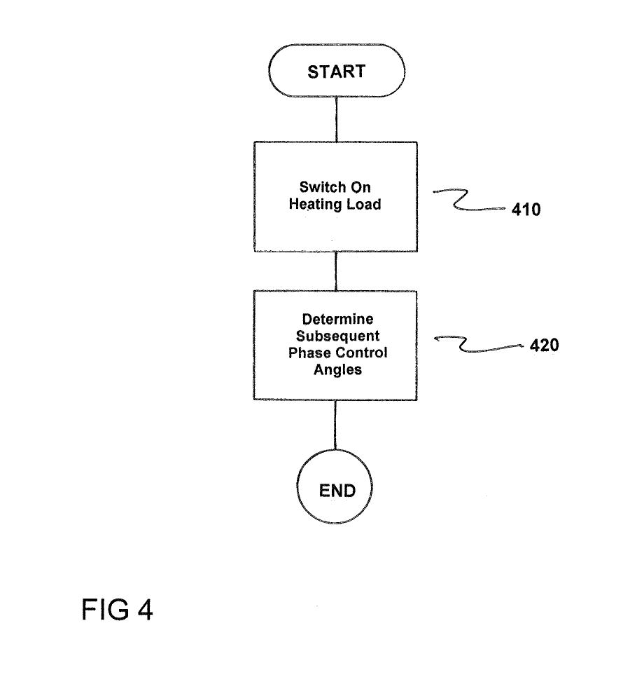

FIG. 4 is a flowchart of the method for switching on a heating load LOAD, where the heating load LOAD is controllable via forward-phase control having a corresponding phase control angle φ1, . . . , φn. The method comprises switching on the heating load LOAD via a specifiable initial phase control angle φINIT, as indicated in step 410. Next, subsequent phase control angles φ1, . . . , φn are determined taking into account an ascertained effective current I_{EFF} and a definable switch-on current curve I_{Start}, as indicated in step 420.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for switching on a heating load, the heating load being controllable via forward-phase control having a corresponding phase control angle, the method comprising:
switching on the heating load via a specifiable initial phase control angle; and
determining subsequent phase control angles taking into account an ascertained effective current and a definable switch-on current curve.

2. The method as claimed in claim 1, wherein the heating load exhibits positive temperature coefficient (PTC) thermistor properties.

3. The method as claimed in claim 1, wherein the initial phase control angle is at least 90°.

4. The method as claimed in claim 3, wherein the initial phase control angle is at least 120°.

5. The method as claimed in claim 2, wherein the initial phase control angle is at least 90°.

6. The method as claimed in claim 5, wherein the initial phase control angle is at least 120°.

7. The method as claimed in claim 1, wherein the phase control angles that follow the initial phase control angle are at least one of (i) calculated from the ascertained effective current and (ii) determined from the ascertained effective current.

8. The method as claimed in claim 1, wherein the initial specifiable phase control angle is selected according to a temperature of the heating load.

9. The method as claimed in claim 1, wherein the definable switch-on current curve does not exceed a characteristic curve of a protective device.

10. The method as claimed in claim 1, wherein a distance between the definable switch-on current curve and a characteristic curve of a protective device is not less than a definable minimum distance.

11. The method as claimed in claim 1, wherein the switch-on is concluded when a phase control angle of 50° or less has been reached.

12. The method as claimed in claim 1, wherein the switch-on is concluded when a phase control angle has been reached which is less than an angle defined by a controller for operation after a switch-on process.

13. The method as claimed in claim 1, wherein the heating load is controlled via half wave control after the switch-on.

14. The method as claimed in claim 1, wherein the method is repeated when a definable cooling time of the heating load is exceeded.

15. The method as claimed in claim 1, wherein the method is repeated whenever the heating load is switched on.

16. A heating control system, comprising:
a power section configured to control a heating load via forward-phase control having phase control angles; and
a controller which controls the power section such that the heating load is switched on utilizing a specifiable initial phase control angle;
wherein subsequent phase control angles are determined taking into account an ascertained effective current and a definable switch-on current curve.

17. The heating control system as claimed in claim 16 wherein the heating control system is configured to:
switch on the heating load via a specifiable initial phase control angle; and
determine the subsequent phase control angles taking into account the ascertained effective current and the definable switch-on current curve.
